(19) United States
(12) Patent Application Publication
(10) Pub. No.: US 2012/0182256 A1
(43) Pub. Date: Jul. 19, 2012

(54) TOUCH SCREEN DEVICE

(75) Inventor: Takashi KITADA, Fukuoka (JP)

(73) Assignee: PANASONIC CORPORATION, Osaka (JP)

(21) Appl. No.: 13/345,887

(22) Filed: Jan. 9, 2012

(30) Foreign Application Priority Data
Jan. 13, 2011 (JP) 2011-004744

(51) Int. Cl. G06F 3/044

(52) U.S. Cl. 345/174

(57) ABSTRACT

A reception signal processor of a touch screen device receives a response signal output from receiving electrodes that have responded to a driving signal applied to transmitting electrodes and outputting detection data of each electrode intersection. The reception signal processor includes an integrator and a monitor. The integrator integrates a signal obtained by performing a predetermined process on an output signal from the receiving electrodes, and the monitor outputs a reset signal when an integrated value of the integrator reaches a predetermined threshold value. The integrator resets the integrated value to zero in response to the reset signal from the monitor. In particular, a smoother that smoothes a signal is provided before the integrator, and the integrator integrates the signal that has been smoothed by the smoother.

### CROSS-REFERENCE TO RELATED APPLICATIONS

The present application claims priority under 35 U.S.C. §119 of Japanese Application No. 2011-004744, filed on Jan. 13, 2011, the disclosure of which is expressly incorporated by reference herein in its entirety.

### BACKGROUND OF THE INVENTION

1. Field of the Invention

The present invention relates to a touch screen device of an electrostatic capacitance type that detects a touch position based on a change in an output signal from an electrode in association with a change in electrostatic capacitance caused by a touch operation.

2. Description of Related Art

Various types of touch screen devices having different principles to detect a touch position exist. Among them, a projection-type electrostatic capacitance touch screen device particularly has superior characteristics such as convenience in use. The projection-type electrostatic capacitance touch screen device utilizes a principle that electrostatic capacitance of a capacitor formed at an intersection of electrodes arranged in a grid pattern changes when a conductive object (human body, for example) approaches or contacts the electrodes. In such a device, a touch operation can be performed directly with a user's fingertip or simply with a stylus made from a conductive material. Further, it is possible to detect a touch position with high accuracy.

Normally, a touch screen device is used in combination of an image display apparatus such as a plasma display panel and an LCD display panel. When a panel body of a touch screen device provided with electrodes is placed at a front surface of an image display apparatus, it is necessary to secure good visibility of a screen of the image display apparatus. This is achieved by configuring the panel body with a transparent material. However, a transparent electrode composed of ITO has high resistance and requires higher production cost, and thus makes it difficult to achieve practical utilization in a large touch screen device.

With respect to the transparent electrode having the above circumstance, a technology is known that employs a mesh-like electrode in which conductive wires are arranged in a net-like state (See Related Art 1 and 2). Such a mesh-like electrode becomes almost invisible by employing finer wiring even when the electrode is made of an opaque metal material. Thus, good visibility of the image display apparatus can be achieved. In addition, it is possible to employ a metal material having low resistance and requiring lower costs, thereby making it easier to achieve practical utilization of a large touch screen device.

The projection-type electrostatic capacitance touch screen device obtains a touch position based on an amount of change ΔC in electrostatic capacitance C at an electrode intersection when a touch operation is performed. Thus, a ratio (ΔC/C) of the change amount ΔC with respect to the electrostatic capacitance C indicates sensitivity for detecting a touch operation. When the mesh-like electrode is employed, the electrostatic capacitance C at the electrode intersection increases by a digit (i.e., a factor of ten). Meanwhile, the amount of change ΔC associated with a touch operation is merely a little less than 10% of the electrostatic capacitance C. Thus, the ratio (ΔC/C) of the change amount ΔC with respect to the electrostatic capacitance C becomes low, which creates a circumstance where the sensitivity of touch detection decreases.

In particular, when a predetermined interpolating method is used to obtain a touch position based on detection data of each electrode intersection, it is possible to detect the touch position at a higher resolution than the placement pitch of the electrodes. However, when the mesh-like electrode is employed and thus the ratio of the change amount ΔC with respect to the electrostatic capacitance C is low, it is difficult to ensure sufficient accuracy in detecting a touch position by use of the interpolating method.
[Related Art 1] Japanese Laid-Open Patent Publication 2006-344163
[Related Art 2] Japanese Laid-Open Patent Publication 2010-039537

### SUMMARY OF THE INVENTION

The present invention is devised to address the above-described circumstance in the conventional technology. The present invention provides a touch screen device configured to accurately detect a touch position even when a ratio of change in electrostatic capacitance at an electrode intersection is low when a touch operation is performed.

A touch screen device according to the present invention includes a panel body provided with a plurality of transmitting electrodes, which are mutually arranged in parallel, and a plurality of receiving electrodes, which are mutually arranged in parallel, the transmitting electrodes and the receiving electrodes being arranged in a grid pattern; a transmitter that applies a driving signal to the transmitting electrodes; a receiver that receives a response signal output from the receiving electrodes that have responded to the driving signal applied to the transmitting electrodes, and outputs detection data of each electrode intersection; and a controller that detects a touch position based on an amount of change in the detection data output from the receiver. The receiver includes an integrator that integrates a signal that is based on the response signal from the receiving electrodes, and a monitor that outputs a reset signal when an integrated value of the integrator reaches a predetermined threshold value. The integrator resets the integrated value to zero in response to the reset signal from the monitor.

According to the present invention, a reset is performed when the integrated value of the integrator reaches the predetermined threshold value. Because the integrator does not saturate, the integrator can be set such that the integrated value significantly changes with respect to an input signal. Accordingly, an amount of change in output detection data from the receiver caused by a touch operation becomes large. Thus, even when a ratio of change in electrostatic capacitance at an electrode intersection associated with a touch operation is low, a touch position can be accurately detected.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows an overall configuration of a plasma display apparatus 1 that incorporates a touch screen device according to the present invention;

FIG. 2 is a plan view illustrating transmitting electrodes 7 and receiving electrodes 8;

FIG. 3 shows a schematic configuration of a reception signal processor 16;

FIG. 4 shows a schematic configuration of an integrator 35;

FIG. 5 shows waveform charts illustrating signals output from each component of the reception signal processor 16;

FIG. 6 shows waveform charts illustrating signals output from each component of a reception signal processor of conventional configuration;

FIG. 7 shows waveform charts illustrating signals output from each component of the reception signal processor 16 in FIG. 5, the signals being enlarged in a time-axis direction;

FIG. 8 shows waveform charts illustrating signals output from each component of the reception signal processor 16 when the number of resets is different between a touch state and a non-touch state;

FIG. 9 shows waveform charts illustrating reset signals, and output signals from the integrator 35; and

FIG. 10 is a flowchart illustrating a procedure for processing performed by a touch position calculator 17.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

Hereinafter, an embodiment of the present invention is described with reference to the drawings.

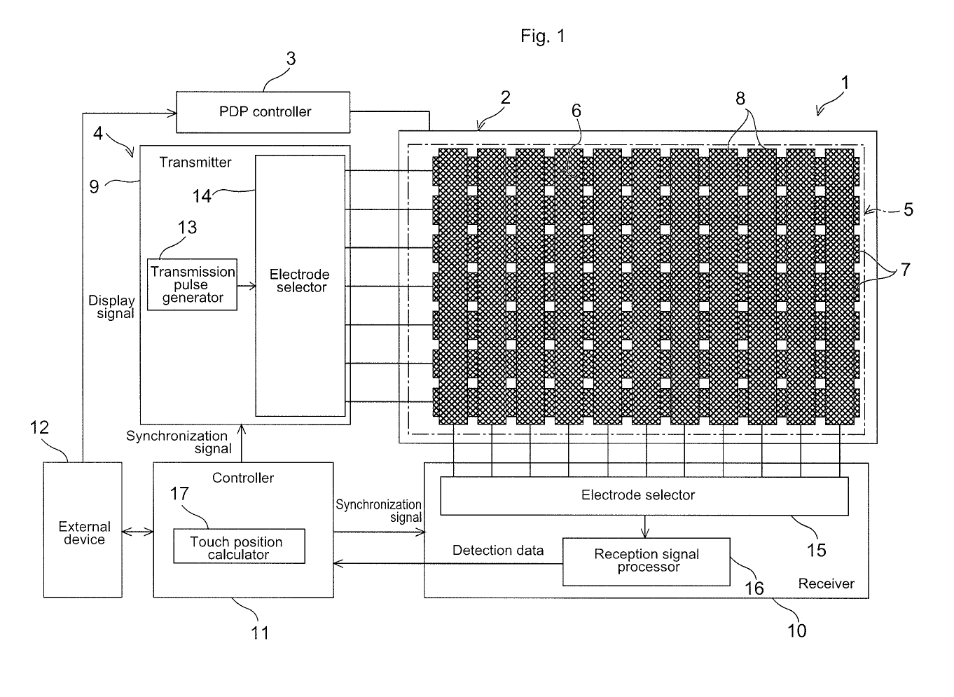

FIG. 1 shows an overall configuration of a plasma display apparatus 1 that incorporates a touch screen device according to the present invention. The plasma display apparatus 1 is configured with a plasma display panel (image display apparatus; hereafter referred to as PDP) 2, a PDP controller 3, and a touch screen device 4. A panel body 5 of the touch screen device 4 is provided on a front side of a display surface of the PDP 2.

The panel body 5 of the touch screen device 4 includes a touch surface 6 where a touch operation is performed by a pointing object (conductive body such as a fingertip of a user, a stylus, and a pointing rod). The touch surface is provided with a plurality of transmitting electrodes 7, which are mutually arranged in parallel, and a plurality of receiving electrodes 8, which are mutually arranged in parallel, the transmitting electrodes 7 and the receiving electrodes 8 intersecting or crossing each other in a grid pattern.

In addition, the touch screen device 4 includes a transmitter 9, a receiver 10, and a controller 11. The transmitter 9 applies a driving signal to the transmitting electrodes 7. The receiver 10 receives a response signal from the receiving electrode 8 that has responded to the driving signal applied to the transmitting electrodes 7 and outputs detection data corresponding to electrostatic capacitance of each electrode intersection where a transmitting electrode 7 and a receiving electrode 8 intersect. The controller 11 detects a touch position based on the detection data output from the receiver 10 and controls operations of the transmitter 9 and the receiver 10.

Information about the touch position is output from the controller 11 and is input to an external device 12 such as a personal computer and the like. Display screen data is generated in the external device 12 and is output to the PDP controller 3 that controls the PDP 2. Accordingly, when a user performs a touch operation using a pointing object on the touch screen 6 of the panel body 5, an image corresponding to the touch operation is displayed on the screen of the PDP 2. Therefore, it is possible to display a desired image in a manner similar to a case where an image is directly drawn on the touch surface 6 with a marker. It is also possible to operate a button and the like displayed on the display screen of the PDP 2. Furthermore, an eraser that erases an image drawn by a touch operation may be used.

The transmitting electrodes 7 and the receiving electrodes 8 intersect in a stacked state having an insulating layer in between. A capacitor is formed on each electrode intersection where a transmitting electrode 7 and a receiving electrode 7 intersect. When the user performs a touch operation with a pointing object such as a finger and the like, and when the pointing object approaches or contacts the touch surface 6, electrostatic capacitance of the electrode intersection essentially decreases. Therefore, it is possible to detect whether or not a touch operation is performed.

In a mutual capacitance type employed herein, a driving signal is applied to the transmitting electrodes 7, and then a charge-discharge current flows in the receiving electrodes 8 in response. The charge-discharge current as a response signal is output from the receiving electrodes 8. A change in the electrostatic capacitance at the electrode intersections at this time in response to a user's touch operation causes a change in the charge-discharge current, which is a response signal, in the receiving electrodes 8. The change amount of the response signal is used to calculate a touch position. In the mutual capacitance type, detection data obtained after processing the reception signal by the receiver 10 is output for each electrode intersection of the transmitting electrode 7 and the receiving electrode 8. Therefore, the mutual capacitance type enables multi-touch (multi-point detection) in which a plurality of touch positions are concurrently detected.

A touch position calculator 17 of the controller 11 obtains a touch position (center coordinate of a touch area) by a predetermined calculation process that uses detection data of each electrode intersection output from the receiver 10. In the touch position calculation, a touch position is obtained based on detection data of each of a plurality of adjacent electrode intersections (4×4, for example) in an X direction (placement direction of the receiving electrodes 8, that is, width direction of the PDP 2) and in a Y direction (placement direction of the transmitting electrodes 7, that is, height direction of the PDP 2) using a predetermined interpolating method (centroid method, for example). Thereby, the touch position can be detected at a higher resolution (1 mm or less, for example) than the placement pitch (10 mm, for example) of the transmitting electrodes 7 and the receiving electrodes 8.

The touch position calculator 17 of the controller 11 obtains a touch position every frame period at which reception of detection data ends for each electrode intersection across the entire surface of the touch surface 6, and outputs the touch position information to the external device 12 in a unit of frame. The external device 12 generates time-line connected display screen data of each touch position based on the touch position information of a plurality of temporally connected frames, and outputs the data to the PDP controller 3. In the case of multi-touch, the touch position information including touch positions by a plurality of pointing objects is output in a unit of frame.

The transmitter 9 includes a transmission pulse generator 13 and an electrode selector 14. The transmission pulse generator 13 generates a pulse as a driving signal. The electrode selector 14 selects the transmitting electrodes 7 one by one, and sequentially applies the pulse output from the transmission pulse generator 13 to the transmitting electrodes 7.

The receiver 10 includes a reception signal processor 16 and an electrode selector 15. The reception signal processor 16 processes a reception signal output from the receiving electrodes 8. The electrode selector 15 selects the receiving electrodes 8 one by one, and sequentially inputs the reception signal from the receiving electrodes 8 to the receiving processor 16.

The transmitter 9 and the receiver 10 operate according to a synchronization signal output from the controller 11. While a pulse signal is applied to one of the transmitting electrodes 7, the receiving electrodes 8 are selected one by one. Reception signals from the receiving electrodes 8 are sequentially input to the reception signal processor 16. By repeating this process on all the transmitting electrodes 7, it is possible to retrieve a reception signal from each of all the electrode intersections.

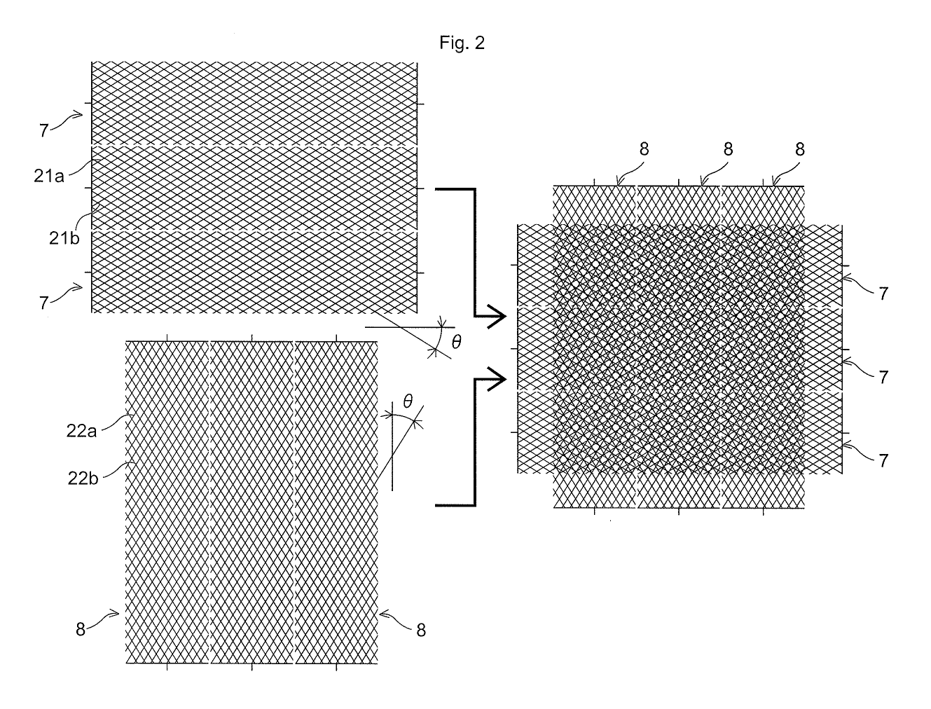

FIG. 2 is a plan view illustrating the transmitting electrodes 7 and the receiving electrodes 8. The transmitting electrode 7 is configured with a mesh-like electrode shape in which conductive wires 21a and 21b are arranged in a grid pattern. The conductive wires 21a extend in a direction inclined at a predetermined angle θ in a clockwise direction with respect to the longitudinal direction of the transmitting electrode 7. The conductive wires 21b extend in a direction inclined at a predetermined angle θ in a counterclockwise direction with respect to the longitudinal direction of the transmitting electrode 7. With the intersection angle 2θ between the conductive wire 21a and the conductive wire 21b being less than 90 degree, the conductive wire 21a and the conductive wire 21b form a consecutive diamond-shape grid pattern. The conductive wires 21a and 21b are electrically connected to each other at intersection portions.

Similar to the transmitting electrode 7, the receiving electrode 8 is also configured with a mesh-like electrode shape in which conductive wires 22a and 22b are arranged in a grid pattern. The arrangement of the conductive wires 22a and 22b is the same as that of the conductive wires 21a and 21b of the transmitting electrode 7.

In the transmitting electrode 7 and the receiving electrode 8 configured as described above, by forming the conductive wires 21a, 21b, 22a, and 22b to have a minute wire diameter, the transmitting electrode 7 and the receiving electrode 8 become almost invisible. Thus, it is possible to improve visibility of a screen of the PDP 2 placed in the rear surface of the touch screen device 4. In addition, it is also possible to inhibit a moiré effect that occurs when the transmitting electrode 7 and the receiving electrode 8 overlap with a pixel pattern of the PDP 2.

When transmitting electrode 7 and the receiving electrode 8 are configured with a mesh-like electrode, while electrostatic capacitance C at electrode intersections becomes large, an amount of change ΔC in electrostatic capacitance caused by a touch operation becomes merely a little less than 10% of the electrostatic capacitance C. Thus, a ratio (ΔC/C) of the change amount ΔC with respect to the electrostatic capacitance C becomes low, that is, sensitivity of touch detection decreases. Therefore, in this embodiment, as described later, the reception signal processor 16, which processes an output signal from the receiving electrodes 8, performs a process to increase the sensitivity so that a touch position can be accurately detected.

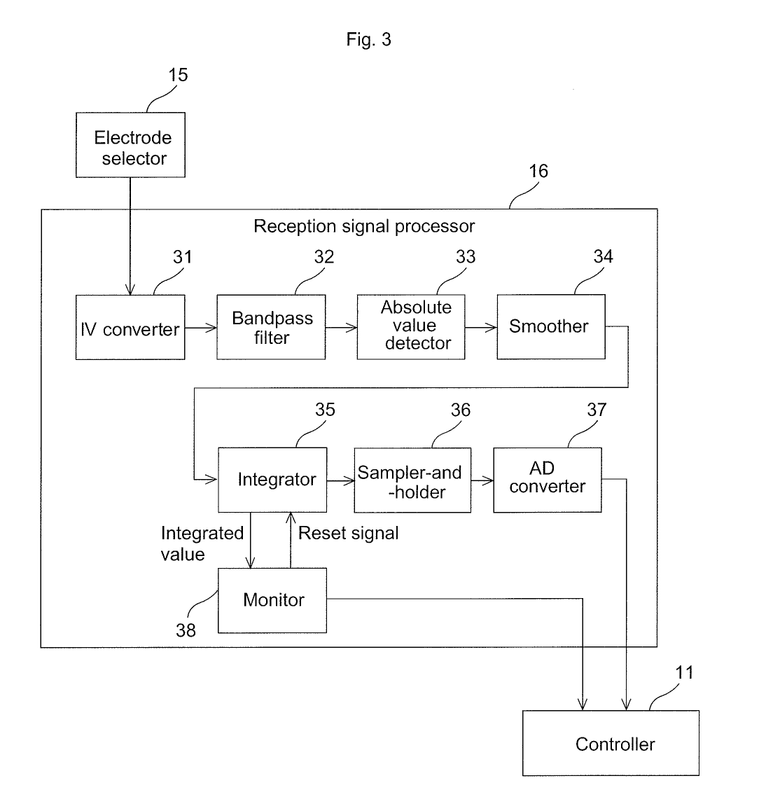

FIG. 3 shows a schematic configuration of the reception signal processor 16. The reception signal processor 16 includes an IV converter 31, a bandpass filter 32, an absolute value detector 33, a smoother 34, an integrator 35, a sampler-and-holder 36, an AD converter 37, and a monitor 38.

The IV converter 31 converts a response signal (charge-discharge current signal) of the receiving electrodes 8, which has been input through the electrode selector 15, into a voltage signal. The bandpass filter 32 removes from the output signals from the IV converter 31a signal having a frequency component other than a frequency of a driving signal applied to the transmitting electrodes 7. The absolute value detector (rectifier) 33 performs a full-wave rectification on the output signal from the bandpass filter 32. The smoother 34 smoothes the output signal from the absolute value detector 33. The integrator 35 integrates the output signal from the smoother 34 in a time axis direction. The sampler-and-holder 36 samples the output signals from the integrator 35 at a predetermined timing. The AD converter 37 performs AD-conversion on the output signal from the sampler-and-holder 36 and outputs detection data for each electrode intersection.

The monitor 38 monitors an integrated value of the integrator 35 and compares the integrated value with a predetermined threshold value. When the integrated value reaches the threshold value, the monitor 38 outputs a reset signal. Specifically, the monitor 38 is configured with a comparator and generates a reset pulse when an output voltage of the integrator 35 reaches a predetermined voltage.

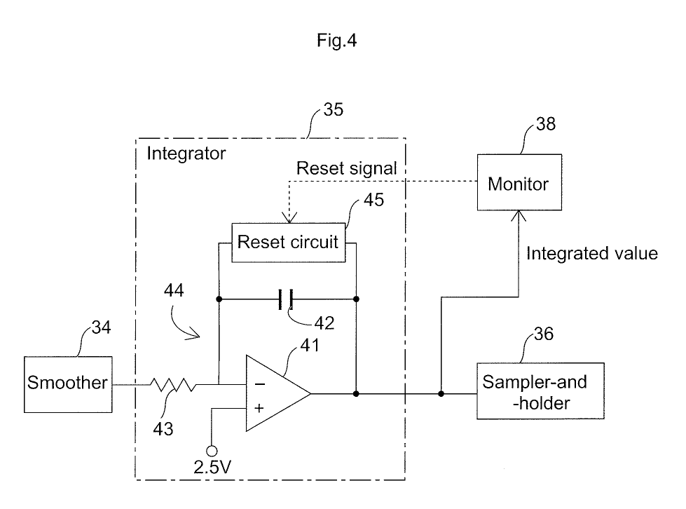

FIG. 4 shows a schematic configuration of the integrator 35. The integrator 35 includes an integration circuit 44 and a reset circuit 45. The integration circuit 44 has a capacitor 42 provided to a feedback circuit between an inverting input terminal and an output terminal of an operational amplifier 41, and a resistance 43. The reset circuit 45 discharges electric charge of the capacitor 42. The integration circuit 44 integrates input voltage by time and outputs the integrated value. When a reset signal from the monitor 38 is input to the reset circuit 45, the integrated value of the integration circuit 44 is reset to be zero. The integration circuit 44 can be set such that output voltage significantly changes with respect to the input signal, by reducing the capacitance of the capacitor 42.

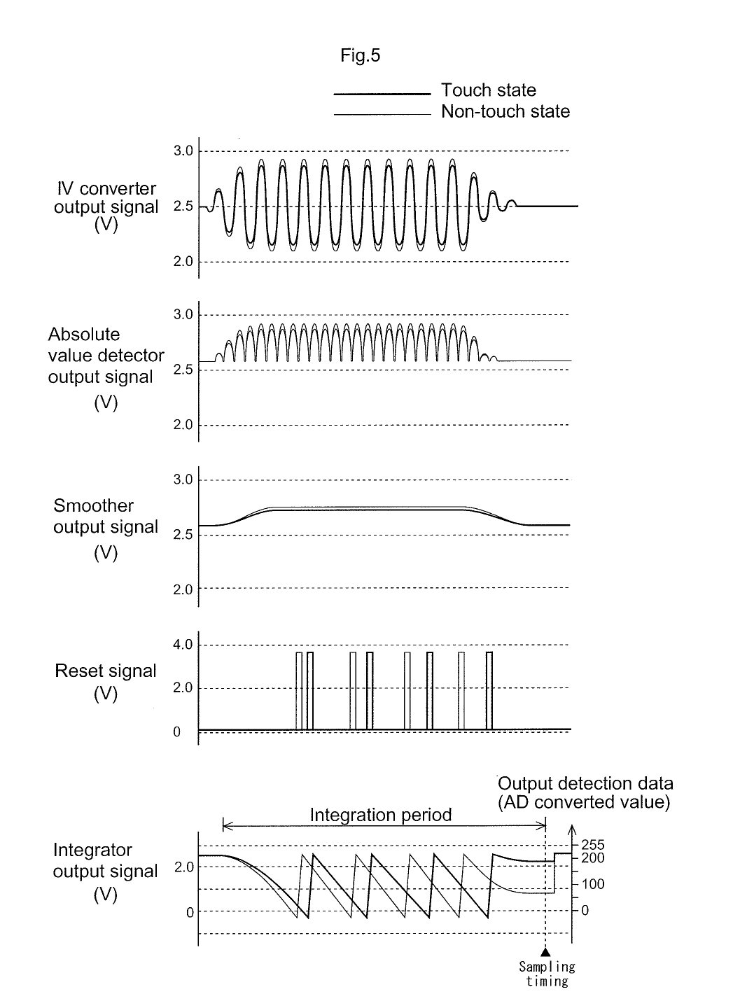

FIG. 5 shows waveform charts illustrating signals output from each component of the reception signal processor 16. When a driving signal (pulse signal) is applied to the transmitting electrodes 7 for the predetermined number of times, charge-discharge current flows in the receiving electrodes 8 in response to a rise and fall of the pulse wave. Accordingly, a voltage signal output from the IV convertor 31 changes.

The integrator 35 resets the integrated value to be zero in response to the reset signal output from the monitor 38. The integration process and the reset are repeatedly performed. The output signal from the IV convertor 31 converges with the end of application of the driving signal to the transmitting electrodes 7. At a predetermined timing when the output signal from the IV convertor 31 converges, the sampler-and-holder 36 samples the output signal from the integrator 35.

When a touch operation is performed, amplitude of a voltage signal output from the IV convertor 31 decreases as electrostatic capacitance at the electrode intersection decreases. In accordance with this, voltage of the output signals from the absolute value detector 33 and the smoother 34 decreases. Accordingly, in a touch state, as compared to a non-touch state, it takes longer before the integrated value of the integrator 35 reaches the threshold value. Thus, a rest is performed later in the touch state than that in the non-touch state.

The sampler-and holder 36 samples the output signal from the integrator 35 at predetermined timing and outputs a voltage signal. The AD convertor 37 converts the voltage signal to detection data (AD converted value) of 8 bit (0 to 255) within a range between 0 and 2.55 V. The AD convertor 37 outputs the detection data to the controller 11. The monitor 38 outputs a reset signal to the controller 11. The controller 11 calculates the number of resets based on the reset signal from the monitor 38.

Electrostatic capacitance C at an electrode intersection can be expressed by the following formula where detection data X being output from the reception signal processor 16, a discarded signal amount T corresponding to an integrated value discarded per reset, and a reset number N being the number of resets.

C=T×N+(T−X) (formula 1)

The touch position calculator 17 of the controller 11 obtains a touch position based on an amount of change ΔC in electrostatic capacitance with respect to an initial value C0 of the electrostatic capacitance in the non-touch state. The amount of change ΔC can be obtained from the following formula based on the formula 1 with the output detection data X of the reception signal processor 16, the reset number N, an initial value X0 of the detection data acquired in the non-touch state, an initial value N0 of the reset number, and the discarded signal amount T per reset.

$$\begin{matrix}Δ C = C 0 - C \\ = \{ T \times N 0 + ( T - X 0 ) \} - \{ T \times N + ( T - X ) \}\end{matrix} \qquad ( formula 2 )$$

The output detection data X of the reception signal processor 16 and the initial value X0 of the detection data vary depending on devices. However, there is little variation in an amount of change ΔC associated with a touch operation. Therefore, a touch operation can be accurately detected by obtaining a touch position based on the amount of change ΔC.

For the convenience of description, electrostatic capacitance C described here indicates detection data of electrostatic capacitance that has been converted with reference to output detection data X of the reception signal processor 16. The electrostatic capacitance C is different from a physical electrostatic capacitance of a capacitor formed at an electrode intersection. In addition, the discarded signal amount T is a value that has also been converted with reference to the output detection data X of the reception signal processor 16.

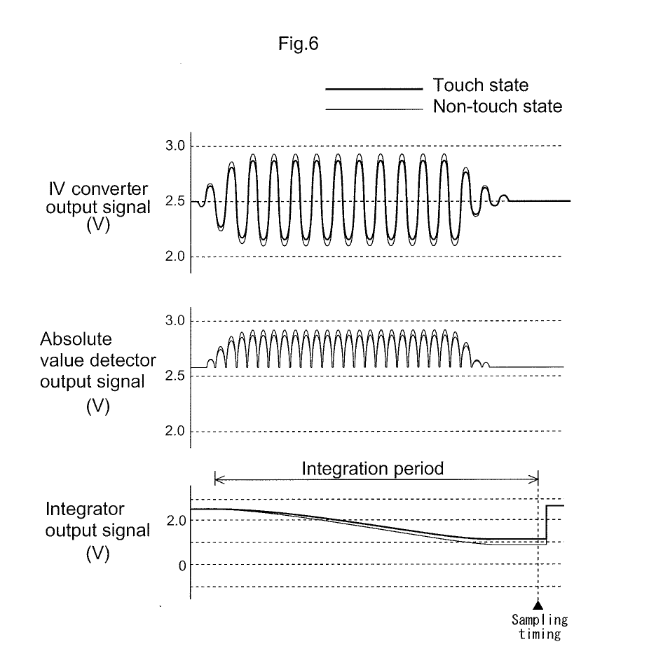

FIG. 6 shows waveform charts illustrating signals output from each component of a reception signal processor of conventional configuration. In the conventional configuration, similar to the present embodiment shown in FIG. 5, an integrator samples an output signal at a timing when an output signal of an IV convertor converges. In order for the integrator not to saturate during an integration period, capacitance of a capacitor in an integration circuit is made large. Thus, an amount of change in output detection data caused by a touch operation is small.

In contrast, in the present embodiment shown in FIG. 5, an integrated value of the integrator 35 is reset in the middle of an integration period, and thus the integrator 35 does not saturate. Accordingly, the integrator 35 can be set such that an integrated value significantly changes with respect to an input signal. Thus, an amount of change in output detection data of the reception signal processor 16 caused by a touch operation becomes large. Thus, with the transmitting electrodes 7 and the receiving electrodes 8 being configured with a mesh-like electrode configuration, a touch position can be accurately detected even when a ratio (ΔC/C) of the amount of change ΔC in electrostatic capacitance at an electrode intersection caused by a touch operation is low.

Each of the receiving electrodes 8 may output signals of different strength due to a variation in electrostatic capacitance at electrode intersections. Thus, there may be a case where input voltage of the integrator 35 is high. Even in such a case, however, the integrator 35 does not saturate, and thus it is possible to ensure accurate touch position detection.

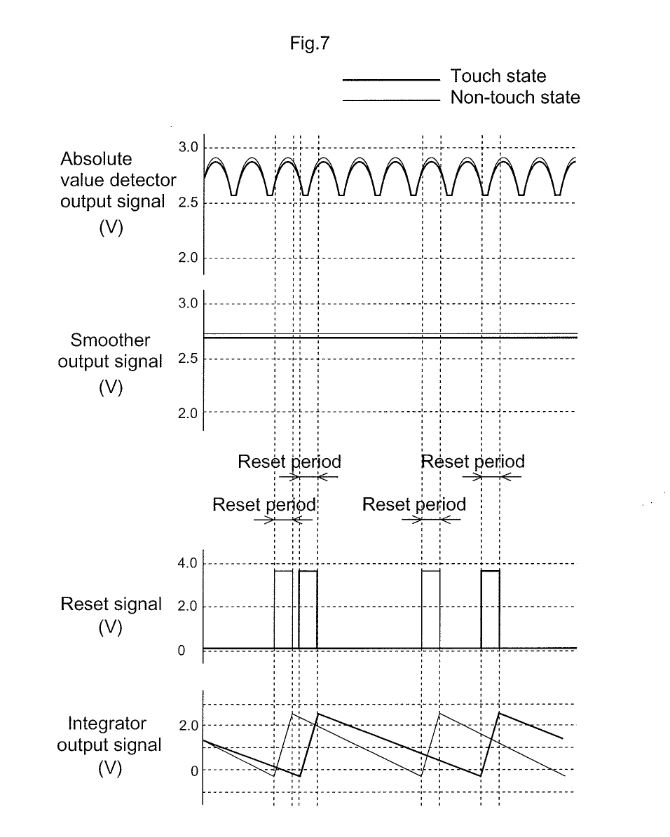

FIG. 7 shows waveform charts illustrating signals output from each component of the reception signal processor 16. FIG. 7 is fundamentally the same as FIG. 5. In order to more clearly show a state of change in output voltage of the absolute value detector 33 during a reset period, a main portion of FIG. 5 is enlarged in a time-axis direction. As shown in FIG. 7, an integration process by the integrator 35 is temporarily stopped during a reset period, and signals input to the integrator 35 during the reset period are nullified without being integrated.

When a touch operation is performed, output voltage of the absolute value detector 23 becomes low with a decrease in electrostatic capacitance at an electrode intersection. Accordingly, it takes longer for an integrated value of the integrator 35 to reach a threshold value. Thus, a reset is performed later in the touch state than that in the non-touch state. In addition, an output signal of the absolute value detector 23 periodically changes. Accordingly, when the output signal of the absolute value detector 23 is integrated as-is, an amount of signals to be nullified during a reset period in the touch state is different from that in the non-touch state, which produces an error in touch position detection.

Accordingly, as shown in FIG. 3, the smoother 34 is provided before the integrator 35 so that the integrator 35 integrates a signal that has been smoothed by the smoother 34. Thus, the integrator 35 receives a constant amount of signals, and the amount of signals nullified during a reset period remains the same even when reset timing is different between the touch state and the non-touch state. Therefore, it is possible to prevent an error in touch position detection caused by different reset timing in the integrator 35.

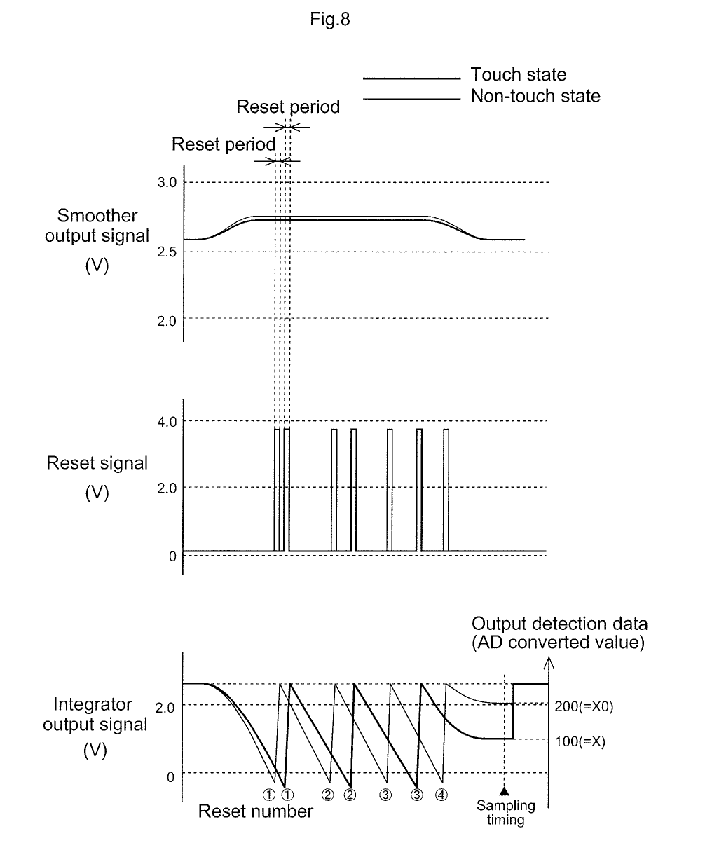

FIG. 8 shows waveform charts illustrating signals output from each component of the reception signal processor 16 in a case where the number of resets is different between the touch state and the non-touch state. As described above, the integration process by the integrator 35 is temporality stopped during a reset period, and signals input to the integrator 35 during the reset period are nullified without being integrated. Thus, the output detection data of the reception signal processor 16 deviates from a true value by an amount of signals input to the integrator 35 during the reset period, thereby generating an error in touch position detection.

The touch position calculator 17 determines a touch position based on an amount of change ΔC in electrostatic capacitance caused by a touch operation. Thus, when the number of resets is the same between the non-touch state and the touch state, errors are offset by each other, thereby causing no problem. However, there is a case where the number of resets is different between the non-touch state and the touch state. In an illustrated example, the number of resets in the touch state decreases to 3 while it is 4 in the non-touch state. In this case, a signal nullified during a reset period becomes an error in touch position detection.

Thus, in this embodiment, when the number of resets is different between the non-touch state and the touch state, the touch position calculator 17 corrects output detection data of the reception signal processor 16 using a correction value corresponding to signals input to the integrator 35 during a reset period. Therefore, it is possible to prevent an error in touch position detection caused by a difference in the number of resets.

A reset period is set to be a certain predetermined period. The smoother 34 smoothes signals before the signals are input to the integrator 35. Thus, an amount of signals input to the integrator 35 during one reset period is constant regardless of timing. Therefore, a correction value for each reset can be determined based on a level of signals output from the smoother 34. The level of the output signals of the smoother 34 is estimated based on output detection data of the reception signal processor 16 acquired immediately after a start-up in the non-touch state and the number of resets, thereby, a correction value is determined.

In addition, the output voltage of the smoother 34 decreases with a touch operation. More specifically, an amount of signals nullified during a reset period is different between the non-touch state and the touch state. When a mesh-like electrode configuration is employed, however, an amount of change in a signal associated with a touch operation is small. Thus, there is no problem in practice even when a correction value is determined based on a signal level in the non-touch state.

In an illustrated example, the reset number N0 in the non-touch state is 4, output detection data X0 is 200, the reset number N in the touch state is 3, and the output detection data X is 100. Therefore, based on the above-described formula 2, an amount of change ΔC is obtained from the following formula.

$$\begin{matrix}Δ C = \{ 255 \times 4 + ( 255 - 200 ) \} - \{ 255 \times 3 + ( 255 - 100 ) \} \\ = 1075 - 920 \\ = 155\end{matrix}$$

Herein, the reset number of the touch state is fewer than that of the non-touch state by one. When a correction value for one reset is 10, a true amount of change ΔC is obtained as 155+10=165.

In the above descriptions, an amount of change ΔC in electrostatic capacitance caused by a touch operation is obtained based on the output detection data of the reception signal processor 16 and the reset number. As describe hereinafter, however, it is also possible to obtain the amount of change ΔC based only on the output detection data of the reception signal processor 16.

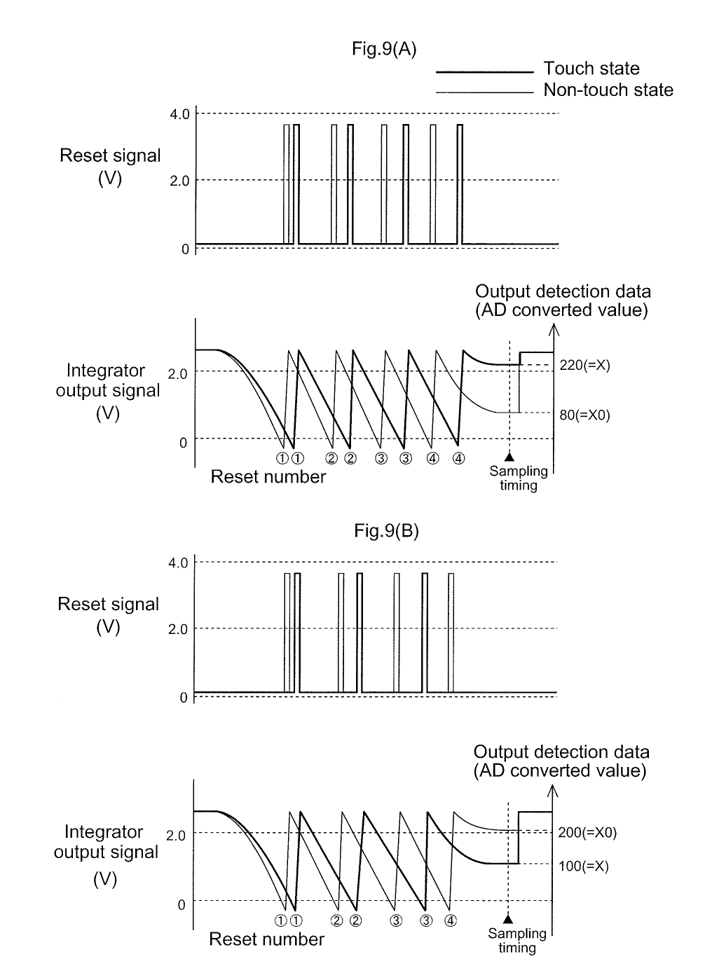

FIGS. 9(A) and (B) show waveform charts illustrating reset signals, and output signals from the integrator 35. FIG. 9(A) shows a case where the reset number is the same between the non-touch state and the touch state. FIG. 9(B) shows a case where the reset number is different between the non-touch state and the touch state.

In an example shown in FIG. 9(A), the reset number is 4 for both the non-touch state and the touch state. In this case, the last reset is performed later in the touch state than in the non-touch state. The output detection data X (=220) in the touch state is greater than the initial value X0 (=80) of the detection data acquired in the non-touch state.

On the other hand, in an example shown in FIG. 9(B), the reset number decreases to 3 in the touch state while it is 4 in the non-touch state. In this case, last reset occurs earlier in the touch state than in the non-touch state. Thus, the output detection data X (=100) in the touch state is smaller than the initial value X0 (=200) of the detection data acquired in the non-touch state.

As described above, the size of output detection data X of the reception signal processor 16 and the size of the initial value X0 are reversed according to a difference in the reset number between the touch state and the non-touch state. Accordingly, it is possible to determine the difference in the reset numbers between the touch state and the non-touch state based on which one of the output detection data X and the initial value X0 is greater. Specifically, when the output detection data X is greater than the initial value X0, it is determined that the reset numbers are the same between the touch state and the non-touch state. In contrast, when the output detection data X is smaller than the initial value X0, it is determined that the reset number in the touch state is fewer that that in the non-touch state by one.

In a case where electrostatic capacitance C in the touch state is smaller than an initial value C0 of electrostatic capacitance in the non-touch state by a discarded signal amount T per reset, that is, in a case where C=C0−T, the reset number in the touch state is smaller than that in the non-touch state by one. However, output detection data X in the touch state is equal to an initial value X0. Thus, it is impossible to distinguish the non-touch state from the touch state based only on the output detection data X and the initial value X0.

Further, in a case where an amount of change ΔC in electrostatic capacitance caused by a touch operation is greater than a discarded signal amount T per reset, output detection data X may be greater than an initial value X0 even when the reset number changes according to a touch operation, similar to the example shown in FIG. 9(A). Thus, it is impossible to distinguish the non-touch state from the touch state based only on the detected amount X and the initial value X0.

Thus, in this embodiment, a discarded signal amount T discarded per reset in the integrator 35 is set to be greater than an amount of change ΔC in electrostatic capacitance caused by a touch operation. This can be achieved by properly setting a threshold value for performing a reset in the integrator 35 and capacitance of the capacitor 42 in the integration circuit 44. Alternatively, in the panel body 5, characteristic of change in electrostatic capacitance associated with a touch operation may be set such that an amount of change ΔC in electrostatic capacitance caused by a touch operation becomes smaller than the discarded signal amount T.

Specifically, for example, electrostatic capacitance C in a touch state is supposed to change only by 15% with respect to an initial value C0 of electrostatic capacitance in a non-touch state. In the case of the example shown in FIG. 9(A), the electrostatic capacitance C0 in a non-touch state, based on the formula 1, is 255×4+(255−80)=1020+175=1195. Thus, the amount of change ΔC caused by the touch operation is 1195×0.15≈180 at greatest, which is smaller than the discarded signal amount T (=255) per reset. Therefore, it is possible to distinguish the non-touch state and the touch state based only on a difference between output detection data X and an initial value X0. It is further possible to determine a difference in the reset number only by comparing the sizes of output detection data X with the size of an initial value X0.

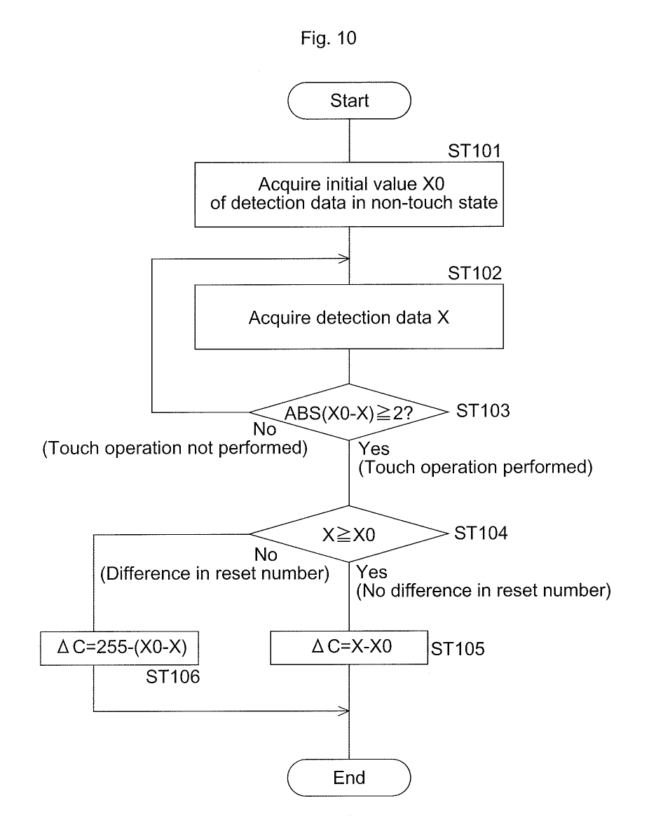

FIG. 10 is a flowchart illustrating a procedure for processing performed by the touch position calculator 17. First, an initial value X0 of output detection data of the reception signal processor 16 in the non-touch state is obtained while calibration is performed at the time of a start-up of a device, (ST101). Then, when the device becomes operable by a user, output detection data value X of the reception signal processor 16 is acquired (ST102). Thereafter, an absolute value (ABS (X0−X)) of the difference between the output detection data X and the initial value X0 is calculated. Whether or not a touch operation is performed is determined based on whether or not the absolute value is greater than or equal to a predetermined reference value (2, in this example).

When it is determined that a touch operation is performed (Yes in ST103), the size of the output detection data X and the size of the initial value X0 are compared. When the output detection data X is greater than or equal to the initial value X0 (Yes in ST104), it is determined that the reset number is the same between the touch state and the non-touch state. In this case, an amount of signals discarded by a reset is the same between the non-touch state and the touch state. Therefore, the output detection data X and the initial value X0 may simply be compared with each other, and the amount of change ΔC caused by a touch operation is obtained from the following formula (ST105).

ΔC=X−X0 (formula 3)

In the case of the example shown in FIG. 9(A), the output detection data X0 in the non-touch state is 80, the output detection data X in the touch state is 220. Thus, the amount of change ΔC is obtained as ΔC=220−80=140.

On the other hand, when the output detection data X is smaller than the initial value X0 (No in ST104), it is determined that the reset number in the touch state is less than that in the non-touch state by one. In this case, an amount of discarded signals per reset is different between the non-touch state and the touch state by the discarded signal amount T (=255) per reset, and an amount of change ΔC caused by a touch operation is obtained from the following formula (ST106).

ΔC=255−(X0−X) (formula 4)

In the case of the example shown in FIG. 9(B), the output detection data X0 in the non-touch state is 200, the output detection data X in the touch state is 100. Thus, the amount of change ΔC is obtained as ΔC=255−(200−100)=155. Further, the correction value (10 in this example) corresponding to signals nullified by being input to the integrator 35 during a reset period is added. Thus, the amount of change ΔC becomes 165.

Whether or not a touch operation is performed is determined (ST103) based on whether or not the difference between the output detection data X and the initial value X0 is within the predetermined range (±2). Thereby, it is possible to prevent a determination error attributed to the variation in the output detection data X.

As described above, the output detection data X of the reception signal processor 16 is compared with the initial value X0 of the detection data acquired in the non-touch state. Based on which one of them is greater than the other, the difference in the reset number between the non-touch state and the touch state is determined. Based on the determined difference in the reset number, the amount of change ΔC in electrostatic capacitance is obtained. Thus, a touch position can be obtained based only on the output detection data X of the reception signal processor 16. Therefore, the necessity of a unit that calculates the reset number is eliminated. In addition, because an amount of data to be processed is reduced, memory capacity can be saved. Furthermore, it is possible to reduce loads for computation and data transfer, thereby improving processing speed (detection rate) of touch position detection.

In the above-described example, the transmitting electrode 7 and the receiving electrode 8 are configured with a mesh-like electrode configuration. However, the present invention is not limited to this configuration. The present invention may be applied to, for example, a configuration in which conductive wires to be electrodes are arranged to extend in one direction.

Further, in the above-described example, as shown in FIG. 3, the smoother 34 is provided before the integrator 35 in the reception signal processor 16. However, an output signal from the absolute value detector 33 may be directly input to the integrator 35 without the smoother 34. Also with this configuration, it is possible to obtain a predetermined effect such that an amount of change in output detection data of the reception signal processor 16 caused by a touch operation becomes large.

Further, in the above-described example, as shown in FIG. 3, the IV convertor 31, the bandpass filter 32, and the absolute value detector 33 are provided to process a response signal from the receiving electrodes 8. However, processing by these components may be omitted as needed. In other words, as long as a signal based on a response signal from the receiving electrodes 8 is input to the integrator 35, the response signal from the receiving electrodes 8 may be directly input to the integrator 35 without performing an IV conversion, a bandpass filtering, or a full-wave rectification. Also with this configuration, it is possible to obtain a predetermined effect such that an amount of change in output detection data of the reception signal processor 16 associated with a touch operation becomes large.

The touch screen device according to the present invention is capable of accurately detecting a touch position even when an amount of change in electrostatic capacitance at an electrode intersection associated with a touch operation is small. The present invention is useful as a touch screen device of an electrostatic capacitance type that can detect a touch position based on a change in an output signal from an electrode caused in accordance with a change in electrostatic capacitance caused by a touch operation.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A touch screen device, comprising:
a panel body provided with a plurality of transmitting electrodes, which are mutually arranged in parallel, and a plurality of receiving electrodes, which are mutually arranged in parallel, the transmitting electrodes and the receiving electrodes being arranged in a grid pattern;
a transmitter that applies a driving signal to the transmitting electrodes;
a receiver that receives a response signal output from the receiving electrodes that have responded to the driving signal applied to the transmitting electrodes, and outputs detection data of each electrode intersection; and
a controller that detects a touch position based on an amount of change in the detection data output from the receiver,
wherein, the receiver includes an integrator that integrates a signal that is based on the response signal from the receiving electrodes, and a monitor that outputs a reset signal when an integrated value of the integrator reaches a predetermined threshold value; and
the integrator resets the integrated value to zero in response to the reset signal from the monitor.

2. The touch screen device according to claim 1, wherein the receiver has a smoother that is before the integrator and smoothes a signal input to the integrator.

3. The touch screen device according to claim 2, wherein the integrator integrates the signal that has been smoothed by the smoother.

4. The touch screen device according to claim 1, wherein the integrator comprises a capacitor.

5. The touch screen device according to claim 4, wherein the integrator comprises a reset circuit that discharges electric charges of the capacitor.

6. The touch screen device according to claim 1, wherein the controller calculates a number of resets.

7. The touch screen device according to claim 6, wherein the controller corrects the detection data output from the receiver with a correction value corresponding to a signal input to the integrator during a reset period, when the number of resets is different between a non-touch state and a touch state.

8. The touch screen device according to claim 1, wherein an amount of signal discarded per reset in the integrator is set to be greater than an amount of change in detection data caused by a touch operation; and
the controller determines whether or not a touch operation is performed based on a difference between the output detection data from the receiver and an initial value of detection data acquired in the non-touch state, and when it is determined that a touch operation is performed, a difference in the number of resets between the non-touch state and the touch state is determined based on which one of the detection data in the touch state and the initial value is greater.

9. The touch screen device according to claim 1, wherein the panel body is located at a front surface of an image display apparatus.

10. The touch screen device according to claim 1, wherein the transmitting electrodes and the receiving electrodes are configured with a mesh-like electrode configuration in which conductive wires are arranged in a grid pattern.

11. The touch screen device according to claim 10, wherein the grid is diamond shaped.

12. The touch screen device according to claim 1, wherein the receiver includes a bandpass filter, an absolute value detector and a smoother upstream of the integrator.

13. The touch screen device according to claim 1, wherein the monitor compares a value output from the integrator with the predetermined threshold value.

14. The touch screen device according to claim 1, wherein the integrator comprises a capacitor in a feedback circuit between an inverting input terminal and an output terminal of an operational amplifier.

15. The touch screen device according to claim 1, wherein the integrated value of the integrator is reset during an integration period.

16. The touch screen device according to claim 1, wherein, when a number of resets during a non-touch state of intersecting electrodes is different than a number of resets during a touch state of the intersecting electrodes, the controller corrects the output detection data of the receiver utilizing a correction value based upon signals input to the integrator during a reset period.
